(19) United States
(12) Patent Application Publication
(10) Pub. No.: US 2010/0044363 A1
(43) Pub. Date: Feb. 25, 2010

(54) HYBRID BROIL SYSTEM - ELECTRIC BROIL ELEMENT

(75) Inventors: Joel Butcher, Clarksville, TN (US); Derek Hughes, White Bluff, TN (US); Jerremy Edward Donoho, Savannah, TN (US); Margaret Mary Sterling, Madison, TN (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., Cleveland, OH (US)

(21) Appl. No.: 12/543,781

(22) Filed: Aug. 19, 2009

Related U.S. Application Data
(60) Provisional application No. 61/090,385, filed on Aug. 20, 2008.

(51) Int. Cl. A21B 1/02

(52) U.S. Cl. 219/405

(57) ABSTRACT

A cooking appliance with a cooking cavity includes a reflective tray mounted in the cooking cavity, a vent located on the reflective tray, and a heating element mounted within the reflective tray that is configured to reflect heat emitted by the heating element. The vent is configured to allow at least moisture from the cooking cavity to pass therethrough. The heating element is mounted relative to the vent such that the vent is horizontally spaced at a distance greater than a thickness of the heating element. In another example, a vent is located on a central portion of the reflective tray and a heating element is located on an outer portion of the reflective tray. In yet another example, a heating element is mounted within a reflective tray at a horizontal location and a vent is located at a different horizontal location than the heating element.

### CROSS-REFERENCE TO RELATED APPLICATIONS

This application claims the benefit of U.S. Provisional Application No. 61/090,385, filed Aug. 20, 2008, the entire disclosure of which is hereby incorporated herein by reference.

### FIELD OF THE INVENTION

The present invention relates generally to a cooking appliance, and more particularly to a heating element mounted within a reflective tray that includes a vent.

### BACKGROUND OF THE INVENTION

Cooking appliances, such as ovens and ranges, often include upper and lower heating elements in a cooking cavity thereof. The upper heating element is often used for broiling operation; while the lower heating element is often used for baking operations. Typically in a gas oven, both the upper and lower heating elements are gas heating elements. Likewise, in an electric oven, typically both upper and lower heating elements are electric heating elements.

### BRIEF SUMMARY OF THE INVENTION

The following presents a simplified summary to provide a basic understanding of some example aspects. This summary is not an extensive overview. Moreover, this summary is not intended to identify critical elements. The sole purpose of the summary is to present some concepts in simplified form as a prelude to the more detailed description that is presented later.

In accordance with one aspect, a cooking appliance with a cooking cavity includes a reflective tray mounted in the cooking cavity, a vent located on the reflective tray, and a heating element mounted within a perimeter of the reflective tray where the reflective tray is configured to reflect heat emitted by the heating element. The vent is configured to allow at least moisture from the cooking cavity to pass therethrough. The heating element is mounted relative to the vent such that the vent is horizontally spaced at a distance greater than a thickness of the heating element.

In accordance with another aspect, a cooking appliance with a cooking cavity includes a reflective tray mounted in the cooking cavity, a heating element mounted within the reflective tray where the reflective tray is configured to reflect heat emitted by the heating element; and a vent located on a central portion of the reflective tray. The heating element is located in an outer portion of the reflective tray. The vent is configured to allow at least moisture from the cooking cavity to pass therethrough.

In accordance with yet another aspect, a cooking appliance with a cooking cavity includes a reflective tray mounted in the cooking cavity, a heating element mounted within the reflective tray at a horizontal location where the reflective tray is configured to reflect heat emitted by the heating element, and a vent located on a portion of the reflective tray at a different horizontal location than the heating element. The vent is configured to allow at least moisture from the cooking cavity to pass therethrough.

### BRIEF DESCRIPTION OF THE DRAWINGS

The foregoing and other aspects will become apparent to those skilled in the art to upon reading the following description with reference to the accompanying drawings, in which:

FIG. 1 is a perspective view of an example cooking appliance.

FIG. 2 is a side view of the example cooking appliance of FIG. 1 and shows a heating element, a reflective tray, and a pan.

FIG. 3 is a perspective view of the heating element, the reflective tray, and the pan of FIG. 2.

FIG. 4 is an underside view of the reflective tray and the heating element of FIG. 3.

FIG. 5 is an underside view of the reflective tray of FIG. 4.

FIG. 6 is a sectional view of the reflective tray of FIG. 2.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

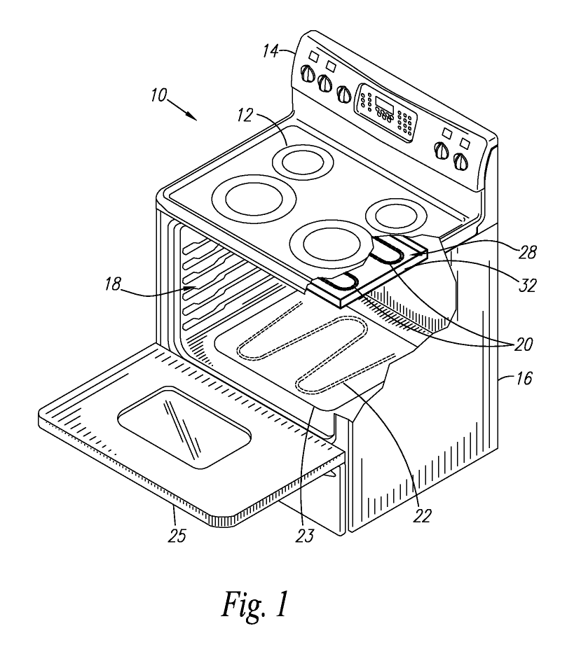

In FIG. 1, an example cooking appliance 10 is shown. In this example, the cooking appliance 10 is an oven or a range that includes a broiling system and a bake system though in other examples, other cooking appliances can be used such as built-in ovens, toaster ovens, warming drawers and ovens, mini-ovens, etc. As will be described in greater detail below, the cooking appliance 10 can include a plurality of heating elements, such as one or more cooktop heating elements 12 provided on a top surface of the cooking appliance 10, an upper heating element 20 and a lower heating element 22 provided in a cooking cavity 18. The cooking appliance 10 includes one or more control elements that can be arranged on a control panel 14. The control panel 14 can be a touch-pad or other touch-sensitive surface. Alternatively or additionally, the control panel 14 can include mechanical controls, such as buttons, knobs or other devices that can be user-operated or actuated. Any desirable orientation and configuration can be used for the control panel 14. For example, the control panel 14 can be placed on or near any desired surface of the cooking appliance 10. In the present example, the control panel 14 is positioned vertically at an upper back portion of the appliance cabinet 16.

Upper heating element 20, which is partially shown in FIG. 1, is positioned at an upper portion of the cooking cavity 18. The upper heating element 20 can be an electric tube broil element, though other suitable electric heating elements can be utilized. Positioned above the upper heating element 20 is reflective tray 28. The reflective tray 28 operates to direct heat radiated from the upper heating element 20 downwardly into the cooking cavity 18, as will be discussed in greater detail herein. The lower heating element 22 is positioned near a bottom portion of the cooking cavity 18. In one example, the lower heating element 22 is covered by a removable panel or plate 23, such as a porcelain plate. The removable plate 23 or panel serves to hide the lower heating element 22 and provides a flat surface that is easily cleaned. The cooking cavity 18 is accessible via a door 25, which is movable between a closed position and an open position.

If desired, the upper heating element 20 and reflective tray 28 can be recessed into a top wall of the cooking cavity 18. Doing so would provide increased cooking space in the cooking cavity 18. Increased cooking space is also provided by utilizing an electric heating element as the upper heating element 20, as gas heating elements require additional components such as, bulky gas pipes, safety valves, igniter systems, baffles, etc.

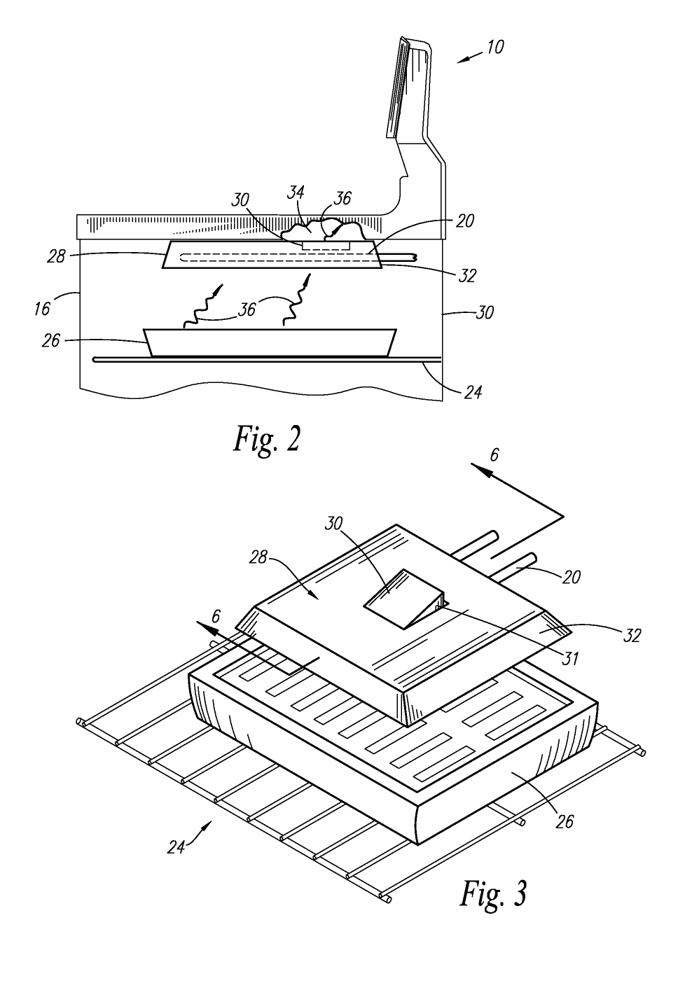

FIG. 2 illustrates a side view of the example cooking appliance of FIG. 1. In FIG. 2, a shelf 24, such as a wire-frame shelf, is provided in a portion of the cooking cavity 18. A pan 26, or other container or cooking surface, can be provided that is supported by the shelf 24. The pan 26 is provided for being heated in a location underneath the upper heating element 20 and the pan 26 extends between the sidewalls of the cooking cavity 18. Various items, such as meat or other food, can be placed on the pan 26 when they are desired to be heated. The reflective tray 28 facilitates the distribution of heat in the cooking cavity 18 in a more uniform manner. Accordingly, food items can be cooked more evenly.

The reflective tray 28 includes generally reflective materials. For instance, the reflective tray 28 can be made from galvanized steel and provided with an aluminized coating or an aluminum polish. In this example, the material can reflect approximately 80% of the heat emitted from heating element. It is to be appreciated that the reflective tray 28 can be made from and/or coated with one or more other suitable materials sufficient to reflect heat from the upper heating element 20 into the cooking cavity 18. The configuration of the reflective tray 28 includes a base portion that is substantially surrounded by a sidewall 32. As shown in FIG. 2, the upper heating element 20 can be recessed within the sidewall 32 of the reflective tray 28 such that the upper heating element 20 cannot be seen from a side view of the assembly. However, it is appreciated that the depth of the reflective tray 28 provided by the sidewalls 32 is just one example and other depths can be used. Moreover, if desired the upper heating element 20 may be only partially recessed within the sidewall 32, if desired. As shown, the sidewall 32 can be angled to reflect heat emitted from the upper heating element 20 in a direction downwards towards the cooking cavity 18 at various angles along the perimeter of the reflective tray 28. The configuration of the reflective tray 28 facilitates improved searing capabilities by providing a more uniform distribution of heat. As a result of the improved heat distribution, both searing performance to the surface of a food material and cooking performance to the interior of a food material are improved.

The base portion of the reflective tray 28 includes at least one vent 30 therein. The vent 30 is configured to allow excess moisture and/or steam 36 from the cooking cavity to pass through the reflective tray 28. Such moisture 36 is generally produced in the cooking cavity 18 during the cooking of food items. The vent 30 directs the moisture 36 into a flue 34 or flue channel located above the reflective tray 28. By positioning the vent 30 proximate to the flue 34, a vacuum effect is created that facilitates that transportation and removal of moisture from the cooking cavity 18 through the vent 30 and into the flue 34. As shown in FIG. 3, the vent 30 can be a raised, angled structure with a sloped top wall. In other examples, a vent can be formed from an aperture in the reflective tray 28 without any noticeable change in shape for the reflective tray 28. The vent 30 can also include various shapes and sizes and is not limited to the one example shown.

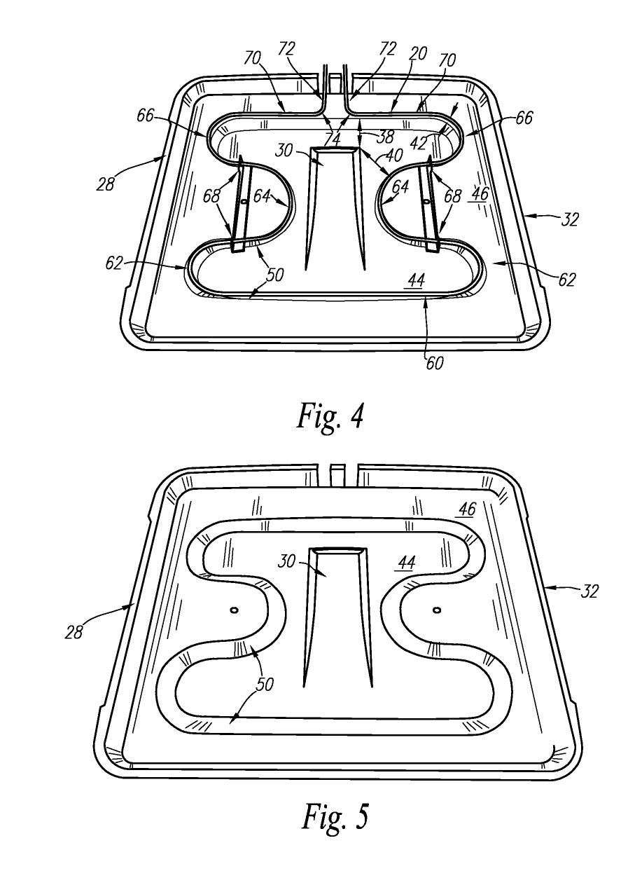

Turning now to FIG. 4, the reflective tray 28 and upper heating element 20 assembly is illustrated in greater detail in accordance with one embodiment. The upper heating element 20 is mounted within a perimeter of the reflective tray 28. The vent 30 is positioned relative to the upper heating element 20 such that the vent 30 is horizontally spaced from the upper heating element 20 at a distance 38 greater than a diameter, or like dimension, 42 of the upper heating element 20. Thus the vent is substantially spaced apart from the upper heating element 20. In other words, heat and moisture are able to pass freely from the cooking cavity through the vent 30 without interference from the upper heating element 20; thereby facilitating more effective venting of the heat and moisture. In the present example, the vent 30 is located in a central portion 44 of the reflective tray 28, while the upper heating element is spaced apart from and substantially surrounds the vent 30.

As shown more clearly in FIG. 5, but can also be seen in FIG. 4, the base portion of the reflective 28 includes a central portion 44 and an outer portion 46. The central portion 44 is recessed with respect to the outer portion 46 and is joined by a transition or in the present example, an embossment 50. The shape of the transition 50 between the central portion 44 and the outer portion 46 corresponds to the shape of the upper heating element 20, as will be described in more detail below. The transition 50 is configured such that it deflects and directs heat to a central area of the cooking cavity 18 located below the central portion 44 of the reflective tray 28.

An example shape for the upper heating element 20 is shown in FIG. 4. The upper heating element 20 is configured to spread or direct heat substantially evenly to all portions of the cooking cavity 18. The upper heating element 20 includes a plurality of linear sections and a plurality of turn sections which may either make a 90° turn or a 180° turn. At a foremost portion, the upper heating element 20 includes a front transverse linear section 60. Each end of the front transverse linear section transitions to a first pair of 180° turn sections 62. The first pair of 180° turn sections 62 transitions to a second pair of 180° turn sections 64 which are succeeded by a third pair of 180° turn sections 66. A second 180° turn section 64 may be joined to a first 180° turn section 62 and a third 180° turn section 66 by a short intermediate transverse linear section 68. The third pair of 180° turn sections 66 is linked by a pair of rearmost transverse linear sections 70 to a pair of 90° turn sections 74. The 90° turn sections lead to a pair of fore-to-aft linear sections 72 which leads rearward to electrical components for operating the upper heating element 20. A variety of other shapes with various turns and other portions can also be used.

In terms of energy requirements for heating performance, the upper heating element 20 can use 1500 watts and be provided with a 120V energy source. This is a reduced amount of electrical power that is needed, in comparison with current electric cooking appliances which typically require 3000 watts or more and a 220V energy source. The reduction in energy required is due in part to the minimization of the interaction of the moisture 36 with the upper heating element 20. Without the disclosed clearance between the vent 30 and the upper heating element 20, moisture 36 would be forced to contact the upper heating element 20 prior to pass through the vent 30. The upper heating element 20 then would require more energy to overcome the moisture 36 that it is subjected to. By providing the vent 30 in a separate and substantially spaced apart location from the upper heating element 20, a larger amount of moisture avoids interaction with the upper heating element 20.

FIG. 5 illustrates the reflective tray 28 in greater detail. The example embossment 50 can be shown in its entirety. The transition 50 is angled upwards from the central portion 44 to the outer portion 46 of the reflective tray 28. This angled configuration facilitates the direction and deflection of heat to different locations in the cooking cavity 18. It is to be appreciated that the specific angle of the transition 50 is related to how the heat is deflected. Accordingly, the transition can be configured to deflect heat in any desirable manner.

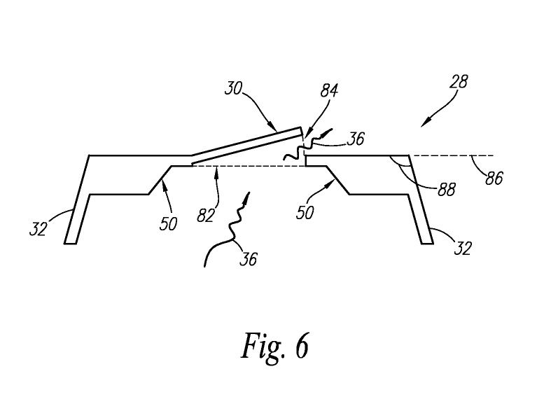

As shown in FIG. 6, a sectional view from FIG. 3 is shown of the reflective tray 28 and of the vent 30. The vent includes a slope or grade between an entry location 82 of the vent 30 and an exit location 84 of the vent 30. This slope allows the moisture 36 that is transported through the vent 30 to exit the reflective tray at a different vertical position than the vertical position of the reflective tray 28 and the upper heating element 20. The location of the vent 30 and the slope of the vent 30 are configured to minimize the interaction of the steam or moisture 36 with the upper heating element 20 to thus minimize the negative affects that the steam could have on the heating performance. A vacuum effect is created by both the position of the vent 30 with respect to the flue 34 and the change in air temperature between the cooking cavity 18 and the ambient air. The depth of the vent sidewall 31 relative to the reflective tray 28, as best shown in FIG. 3, helps to provide additional protection and separation of excess moisture 36 from the heat being produced by the upper heating element 20 as the moisture 36 exits the reflective tray 28. Using a single vent in one location of the reflective tray 28 can provide the strongest vacuum effect for the tray and heating element assembly, as opposed to providing a plurality of vents on the reflective tray 28.

The sidewalls 32 of the reflective tray 28 are angled with respect to the horizontal plane 86 of the reflective tray 28. For example the sidewall angle 88, as measured from the base portion of the reflective tray 28 is greater than 90°. This selected angle allows reflected heat to be directed from the location of the upper heating element 20 to a greater area of the cooking cavity. Accordingly, heat is distributed substantially evenly throughout cooking cavity 18. FIG. 6 also shows the angle of transition 50. The transition 50 is used to direct heat to a central area of the cooking cavity 18.

The upper heating element 20 and reflective tray 28 assembly described herein can be used in a gas or electric oven. When used in a gas oven, use of an electric broil element provides many advantages. For instance, in conventional pre-heat operation, users typically select the bake model and then wait for the cooking appliance to preheat to the selected temperature. By using a hybrid appliance, the user can activate both the upper electric heating element 20 and a lower gas heating element 22, thereby reducing the preheat time. Moreover, a user can activate the upper heating element 20 near the end of a baking operation or baking cycle to brown the top of a food item, such as if a user wanted to brown the top of a casserole. The example cooking appliance 10 also allows users to select temperature levels for the upper heating element 20. Thus, users can also toast an open-faced sandwich or grill a steak by selecting a high temperature setting or by selecting a low temperature setting. In conjunction, the upper heating element 20 and the reflective tray 28 achieve better broil performance than current designs by requiring less electrical energy, less gas, providing a larger cooking cavity, and providing improved searing capabilities.

The invention has been described with reference to the examples described above. Modifications and alterations will occur to others upon a reading and understanding of this specification. Examples incorporating one or more aspects of the invention are intended to include all such modifications and alterations insofar as they come within the scope of the appended claims.

What is claimed is:

1. A cooking appliance with a cooking cavity including:
a reflective tray mounted in the cooking cavity;
a vent located on the reflective tray, wherein the vent is configured to allow at least moisture from the cooking cavity to pass therethrough;
a heating element mounted within a perimeter of the reflective tray wherein the reflective tray is configured to reflect heat emitted by the heating element; and
wherein the heating element is mounted relative to the vent such that the vent is horizontally spaced at a distance greater than a thickness of the heating element.

2. The cooking appliance according to claim 1, further including:
an embossment located about an outer perimeter of the heating element;
wherein the embossment directs heat to a central area of the cooking cavity.

3. The cooking appliance according to claim 1, further including:
a flue located above the reflective tray;
wherein a vacuum effect for transporting and removing moisture from the cooking cavity is created by placing the vent of the reflective tray in alignment with the flue.

4. The cooking appliance according to claim 1, wherein the vent further includes a slope between an entry location of the vent and an exit location of the vent.

5. The cooking appliance according to claim 1, wherein the reflective tray includes a sidewall wherein the heating element is located within at least one sidewall of the reflective tray.

6. The cooking appliance according to claim 5, wherein the sidewall has an angle of greater than 90° relative to a horizontal axis of the reflective tray.

7. The cooking appliance according to claim 1, wherein the heating element is electric and is configured to be activated to pre-heat a gas heating element that is used in the cooking cavity.

8. The cooking appliance according to claim 1, wherein the heating element is electric and is configured to be activated at an end of a baking cycle to brown the top of a food item.

9. A cooking appliance with a cooking cavity including:
a reflective tray mounted in the cooking cavity;
a heating element mounted within the reflective tray wherein the reflective tray is configured to reflect heat emitted by the heating element;
a vent located on a central portion of the reflective tray, wherein the heating element is located in an outer portion of the reflective tray and wherein the vent is configured to allow at least moisture from the cooking cavity to pass therethrough.

10. The cooking appliance according to claim 9, further including:
an embossment located about an outer perimeter of the heating element;
wherein the embossment directs heat to a central area of the cooking cavity.

11. The cooking appliance according to claim 9, further including:
a flue located above the reflective tray;
wherein a vacuum effect for transporting and removing moisture from the cooking cavity is created by placing the vent of the reflective tray in direct proximity with the flue.

12. The cooking appliance according to claim 9, wherein the reflective tray has a thickness and the vent further includes a slope between an entry location of the vent and an exit location of the vent.

13. The cooking appliance according to claim 9, wherein the reflective tray includes a sidewall wherein the heating element is located within at least one sidewall of the reflective tray.

14. The cooking appliance according to claim 13, wherein the sidewall has an angle of greater than 90° relative to a horizontal axis of the reflective tray.

15. The cooking appliance according to claim 9, wherein the heating element is electric and is configured to be activated to pre-heat a gas heating element that is used in the cooking cavity.

16. The cooking appliance according to claim 9, wherein the heating element is electric and is configured to be activated at an end of a baking cycle to brown the top of a food item.

17. A cooking appliance with a cooking cavity including:
a reflective tray mounted in the cooking cavity;
a heating element mounted within the reflective tray at a horizontal location wherein the reflective tray is configured to reflect heat emitted by the heating element;
a vent located on a portion of the reflective tray at a different horizontal location than the heating element, wherein the vent is configured to allow at least moisture from the cooking cavity to pass therethrough.

18. The cooking appliance according to claim 17, further including:
an embossment located about an outer perimeter of the heating element;
wherein the embossment directs heat to a central area of the cooking cavity.

19. The cooking appliance according to claim 17, wherein the reflective tray has a thickness and the vent further includes a slope between an entry location of the vent and an exit location of the vent.

20. The cooking appliance according to claim 17, wherein the vent further includes a slope between an entry location of the vent and an exit location of the vent.
